(19) United States
(12) Patent Application Publication
(10) Pub. No.: US 2007/0165802 A1
(43) Pub. Date: Jul. 19, 2007

(54) Location resolution using call detail records

(76) Inventor: Brandon W. Fox, Charlotte, NC (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 11/472,600

(22) Filed: Jun. 22, 2006

Related U.S. Application Data
(60) Provisional application No. 60/759,804, filed on Jan. 18, 2006.

(51) Int. Cl. H04M 15/00

(52) U.S. Cl. 379/114.03

(57) ABSTRACT

A method of tracking personnel includes receiving incoming communications from the personnel via a telephone network from various locations and matching records of the incoming communications with phone company data generated after calls are completed for billing purposes so as to verify a location from which each incoming communication originated. A system of tracking personnel includes a system receiving incoming communications from the personnel via a telephone network from various locations and automatically matching records of the incoming communications with phone company data generated after calls are completed for billing purposes so as to verify a location from which each incoming communication originated.

### RELATED APPLICATION

The present application claims the priority under 35 U.S.C. §119 of previous U.S. Provisional Patent Application No. 60/759,804, filed Jan. 18, 2006, which application is hereby incorporated by reference in its entirety.

### BACKGROUND

Many companies require a method of tracking the location and movements of remote employees such as field-based nurses, repair technicians, delivery personnel, and other representatives. Verification of the time of arrival and departure of such employees at remote work locations facilitates employee supervision, customer billing and verification that services were provided as scheduled.

One attractive solution allows workers to record arrival and departure times by making a phone call from a remote work location. Telephones are accessible from most locations and phone records are not easily falsified. Consequently, no significant investment need be made in a more sophisticated method of tracking the location and movements of remote employees.

Some existing systems that use phone calls to track the activity of remote employees use Automatic Number Identification (ANI) data to verify the origin and time of a call made by an employee at a remote site. However, these systems would not function without the ANI service, and ANI is not available or desired in all cases. Companies that desire ANI support must install costly equipment or pay additional telephone service charges to receive support. Dependence on ANI data limits the usefulness and flexibility of these systems.

Other systems use widely-available caller-ID data. These systems are not as expensive to implement as ANI-based systems, but caller-ID can be easily blocked with the free *67 command or through permanent caller-ID blocking. Without this data, a caller-ID based tracking system is unusable.

An alternative is therefore needed to accurately track and verify the location of a caller without relying on ANI or caller-ID data, particularly for purposes of tracking the location, time of arrival, etc. of workers at remote locations.

### SUMMARY

A method of tracking personnel includes receiving incoming communications from the personnel via a telephone network from various locations and matching records of the incoming communications with phone company data generated after calls are completed for billing purposes so as to verify a location from which each incoming communication originated. A system of tracking personnel includes a system receiving incoming communications from the personnel via a telephone network from various locations and automatically matching records of the incoming communications with phone company data generated after calls are completed for billing purposes so as to verify a location from which each incoming communication originated.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 is a schematic overview of an exemplary location resolution system.

FIG. 2 is a schematic diagram of the external connections to the system of FIG. 1.

FIG. 3 is a block diagram of the hardware and software components in an example of a location resolution system according to principles described herein.

FIG. 4 is an exemplary database table illustrating types of data useful for location resolution.

FIG. 5 is a flowchart depicting an exemplary method of operation of the system of FIG. 1.

FIG. 6 is a flowchart illustrating an exemplary process view of principles described herein.

FIG. 7 is a software flowchart of an exemplary loop used to match Call Detail Record (CDR) data to received calls.

FIG. 8 is a software flowchart of an exemplary QueryMatch function, which attempts to match a call with its corresponding CDR record.

FIG. 9 is a software flowchart if an exemplary SingleMatch function, which updates database records once a match has been made.

Throughout the drawings, identical reference numbers designate similar, but not necessarily identical, elements.

### DETAILED DESCRIPTION

The present specification describes, among other things, a method for locating the origin of a series of telephone calls using billing data provided by the telephone company. Calls are received and recorded, along with input from the caller. Information is then received after the calls, in the form of Call Detail Record (CDR) data, for example, which indicates the originating location of the calls. Location data and other data can be accurately determined by matching local records of received calls with records received from the telephone company. Many types of information can be used to correlate received calls with telephone company records, including, but not limited to, date, time, and duration of calls, dialed telephone numbers, and information entered during the calls.

The present specification also describes a computer system equipped and configured to receive and process telephone calls. The system also requests new CDR records from a telephone company server and downloads them when available. The system also matches the received calls to their corresponding CDR entries.

While the tracking of remote employees and other personnel is an ideal application for this system and method, the usefulness of the principles described herein extends beyond employee tracking. The methods and systems described herein may be practiced in any arrangement when it is desirable to determine the originating number or location of a call and instant notification is not critical. In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

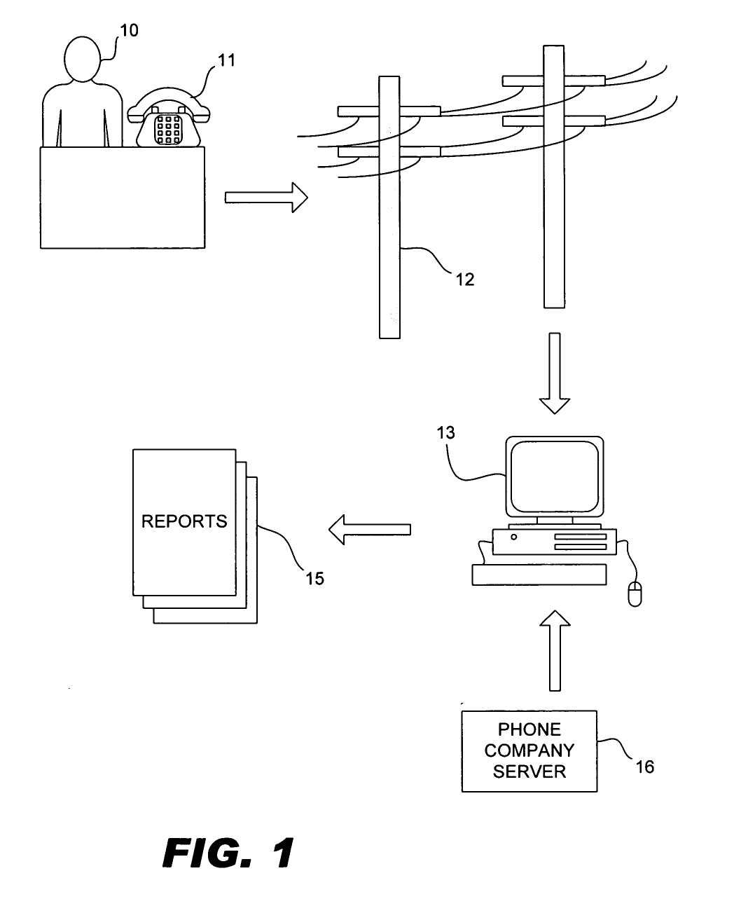

FIG. 1 represents an overview of a location resolution system, according to one exemplary embodiment of the principles described herein.

When an employee or other personnel being monitored (10) arrives or departs from a remote worksite, he or she may signal the arrival or departure using a telephone (11). The remote employee initiates a call which is carried over a telephone network (12) and connected to the location resolution system (13). Once the call is connected, the employee enters an identification code and may enter additional information including, but not limited to, a client identification code, a job identification code, or location code. This information may be entered using touchtone dialing, rotary dialing, voice recognition, or other means of communication over a phone line, such as modem or fax transmission. Although a traditional wired phone network or Plain Old Telephone System (POTS) is depicted in the figure, calls may be additionally or alternatively transmitted over other networks including, but not limited to, wireless or internet protocol (IP) networks.

The location resolution system (13) includes a computer and additional software and hardware for processing phone calls. The system may be located in any location with a wired or wireless connection to one or more telephone networks. The system may also have access to the internet through the same telephone network or independently of the telephone network. Accordingly, the system may reside in a central location for a tracking service provider or at any suitable site chosen by the owner or operator of the system.

After at least one call is completed to the location resolution system, the system requests Call Data Record (CDR) data from at least one phone company server (16). The CDR data is generated by each phone company for billing purposes and includes such information as, but not limited to, originating phone number, call date, call time, and duration of the call. Customers are billed for the services of the phone company based on the CDR data.

The system (13) downloads new CDRs through an internet connection, for example, and then matches calls received from remote employees (10) being monitored to corresponding CDR entries. Once a received call has been matched to its corresponding CDR entry, the location of the calling employee is determined and/or verified using the originating location of the call and the originating phone number from the CDR that has been matched to the call from the monitored employee (10). Since the location resolution uses phone company records, e.g., CDRs, that are generated and obtained by the system (13) after a call is completed, no ANI or caller-ID data is required.

Finally, the location resolution system compiles and sorts the matched records to generate reports (15). The reports (15) may be generated periodically or in response to an explicit request, and the recipient of the report may vary according to a policy established by the owner or operator of the system. Some reports (15) may include detailed information including, but not limited to, the arrival and departure time of each employee at each location, the duration of each visit, a code or classification of each task, a client name or code, or any other data stored in the system. Some reports (15) may display aggregate data sorted by employee, client, location, date, time, or other data field. The exact content of each report (15) may be adjusted to fit the needs and preferences of the recipient.

Reports (15) may be printed, displayed visually, transmitted audibly, transmitted electronically, transferred on magnetic, optical, semiconductor, or other media, or stored in any form of data storage.

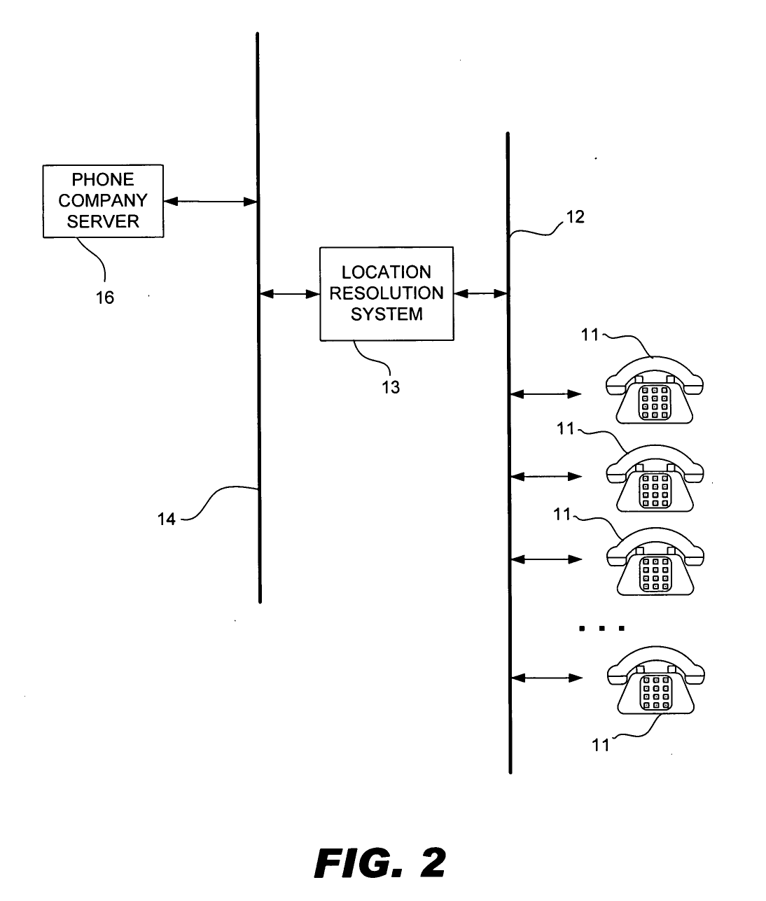

FIG. 2 illustrates network connectivity and sources of input for an exemplary location resolution system (13).

The location resolution system (13) is connected to the internet (14). The connection may be made through a local area network (LAN), wide area network (WAN), dial-up network, wireless network, digital subscriber line (DSL), or other network connection. Through the internet connection, the location resolution system (13) monitors the website or server (16) of at least one telephone company for new CDR data. When an unprocessed CDR file is found, the location resolution system (13) downloads the file from the phone company server (16) and saves the CDR file to local memory.

The location resolution system (13) may also be connected to a phone network (14). As described above, this network (14) may be or include any type of phone network including, for example, a wireless network or POTS. Through this network (14), any number of telephones (11) may access the system (13) by calling at least one number assigned to the location resolution system (13). The system (13) may be configured to receive multiple incoming calls simultaneously. The number of simultaneous calls that the location resolution system (13) may receive depends on the hardware and software configuration of the location resolution system.

While connected to at least one telephone (11), the location resolution system (13) may transmit data or messages as well as receive data. Transmissions may provide information to remote users of the system or request additional input.

While telephones (11) are illustrated in FIG. 2, some embodiments of the system may include computers or computer terminals that are connected to the telephone network (12) and that communicate with the location resolution system (13) on a dial-up basis using the telephone network (12).

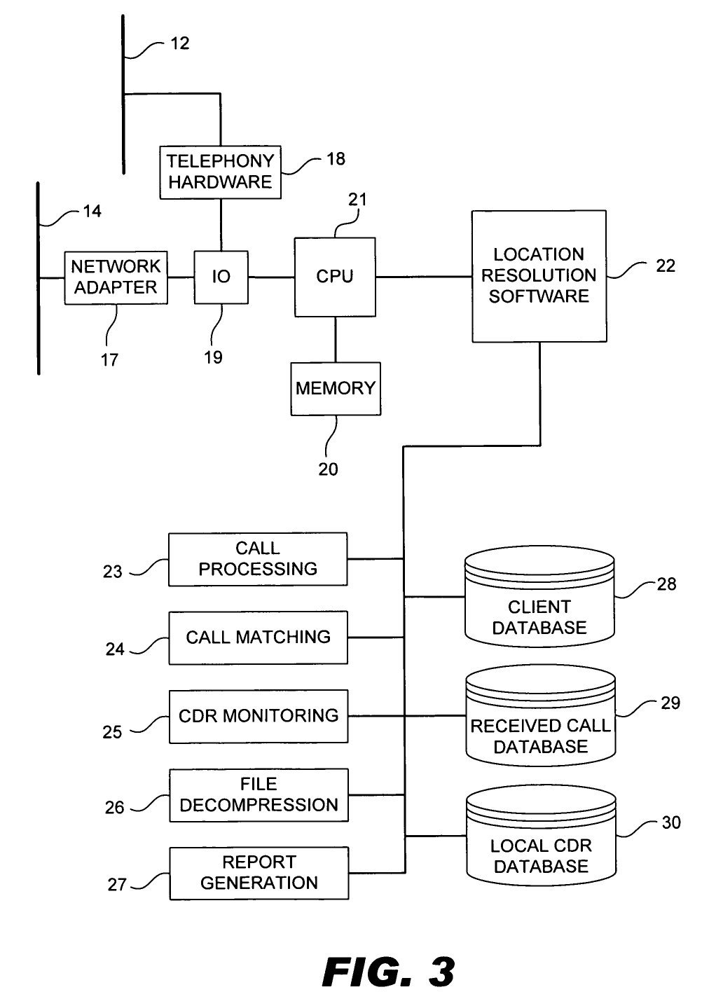

FIG. 3 illustrates the major hardware and software components of the location resolution system, according to one exemplary embodiment.

The CPU (21) executes location resolution software (22) which controls the functions of the system. With the associated memory (20) and input and output system (I/O) (19), the CPU (21) also executes background tasks and operating system tasks as necessary. Memory (20) may include temporary memory, such as random access memory (RAM), and long-term memory such as a hard disk drive, Flash memory, etc.. The I/O (19) module (19) includes all other computer components necessary for the system to interface with peripherals such as displays, input devices, and network adapters.

The network adapter (17) provides access to the internet (14). This may be a modem for dial-up networking (DUN), an Ethernet adapter for accessing a local area network (LAN) or wide area network (WAN), or a cable modem, a digital subscriber line (DSL) modem, wireless network adapter, or other means of accessing the internet.

Telephony hardware (18) provides the system with connectivity to one or more phone networks (12) as described above. Suitable telephony hardware (18) may comprise modems and switches and may include circuitry that is compliant with Telephony Application Programming Interface (TAPI), Telephony Server Application Programming Interface (TSAPI), Private Branch Exchange (PBX), and/or proprietary phone network interface standards. As indicated above, telephony hardware (18) may include support for multiple simultaneous telephone lines or calls.

In the illustrated example, location resolution software (22) includes call processing software (23), call matching software (24), CDR monitoring software (25), file decompression software (26), and report generation software (27). Additionally, location resolution software (22), or a processor executing the location resolution software (22), has connectivity to a client database (28), received call database (29), and local CDR database (30).

Call processing software (23) manages calls connected through the telephony hardware (18). The call processing software (23) adds entries to the received call database (29) and saves information about each call, including, but not limited to, date, time, call duration, and optionally Dialed Number Identification Service (DNIS) digits.

The call processing software (23) also interprets employee data entered during the call, such as location codes, employee identification codes, client codes, or job identification codes and determines appropriate locations, employees, clients, and jobs to match the codes. In one embodiment, the call processing software (23) accesses the client database (28) to associate client and job data with data received during a call from a remote employee. For example, if the remote employee enters a code for a client that requests multiple tasks, the call processing software (23) could look up the number of tasks scheduled for that client and request a code for the specific task to which the employee is assigned and which the employee is performing or has completed. During a call, the call processing software (23) may also transmit a message to an employee in order to request additional information or provide information. The message or request transmitted may vary depending on the circumstances of the call and the information received by the system.

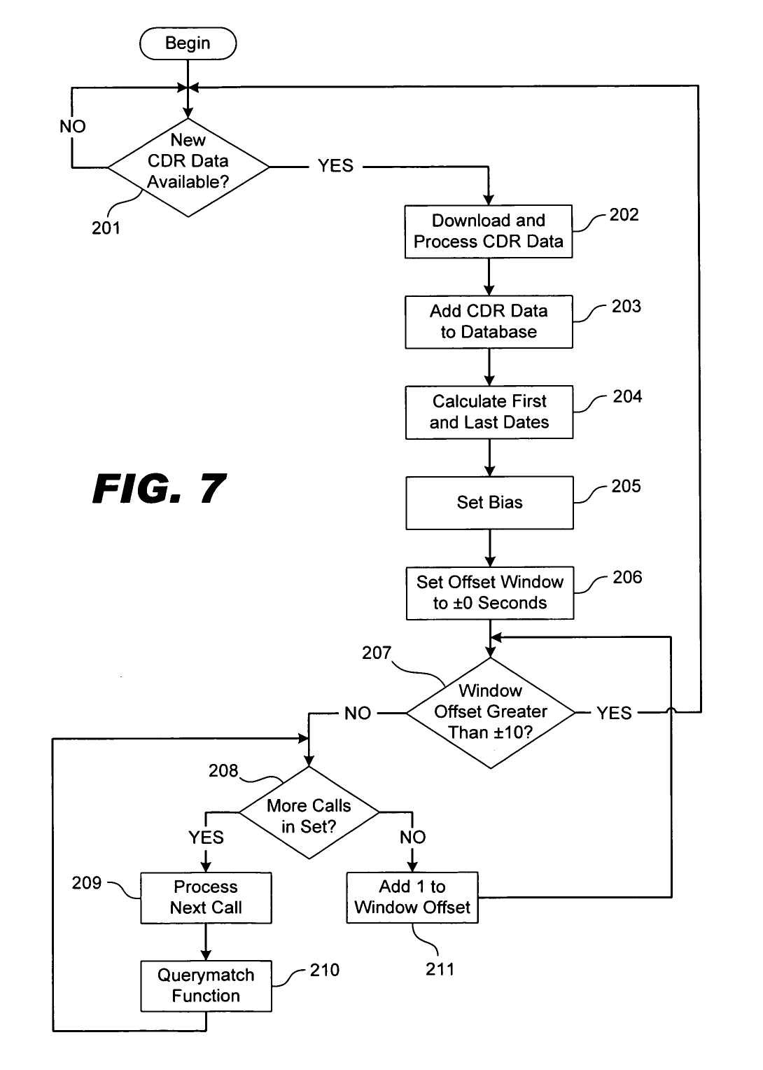

Call matching software (24) matches records of calls received by the system with CDR records downloaded from the telephone company. The call matching process requires an accurate log of calls received from remote employees or other monitored personnel, stored in the received call database (29), and potentially matching CDR records, stored in the local CDR database (30). Using a process such as the one illustrated in FIG. 7 through FIG. 9 and described below, the call matching software (24) correlates each received call entry from a monitored employee with a corresponding CDR entry.

Once matches are found, the call matching software (24) updates the entries in each database. Matched entries in the local CDR database are marked with a code linking them to the correct received call entry and may be excluded from further matching searches. Matched entries in the received call database (29) are also marked as matched and are updated with location data or and additional data extracted from the matching CDR entry. Entries in the client database (28) are also updated to reflect services rendered, billing updates, job status, and other attributes inferred from matched calls.

For matching to be effective, the local CDR database (30) must be updated as new data becomes available. CDR monitoring software (25) periodically queries the telephone company website for unprocessed CDR files and downloads them for processing when available. While the CDR database (30) is described here as being “local,” it will be understood by those skilled in the art that the CDR database (30) may reside anywhere provided that it can be searched for matches to calls received from monitored personnel. Consequently, the CDR database (30) may reside at the same location as the location resolution software (22), on a network accessible to the processor executing the location resolution software (22), on the system or server operated by the telephone company that generates the CDR database (30), etc.

CDR data files may be received in a compressed format. File decompression software (26) decompresses the file to a useable form. Downloaded files may also be received in an encrypted, password-protected, or non-standard form. In some embodiments, the file decompression software (26) is configured to decrypt, authorize, and/or convert files when necessary.

Once CDR data has been processed, the CDR monitoring software (25) imports each CDR entry into the local CDR database (30). The CDR monitoring software (25) can also signal the call matching software (24) to indicate that new CDR data is available and the matching process may begin for the new CDR entries.

Report generation software (27) organizes and outputs records of the matched calls. These reports may be printed, transmitted or stored electronically, displayed visually, stored on optical, magnetic, or other media, or otherwise represented. The content of the reports is selected, for example, from the entries in the client database (28), received call database (29), and local CDR database (30) and may be formatted according to the preferences of the user.

The client database (28) stores information about the clients for which remote employees are providing service. This information includes, but is not limited to, client name, client locations and addresses, current tasks, identification codes, official phone numbers, and previously used phone numbers. This data is used to match phone calls to CDR records and to generate reports.

In one embodiment, the client database (28), received call database 29, and local CDR database 30 are managed and accessed through an SQL Server. Suitable database platforms include, but are not limited to, MySQL, PostgreSQL, Oracle Database, IBM Informix, and IBM DB2. Another embodiment stores the data from these three databases in a single database and uses tables and fields to organize the data. The database server may be an external server, connected locally or through a remote connection, or a program running on the same CPU (21) as the location resolution software (22). Other embodiments store this data in other data structures other than a database.

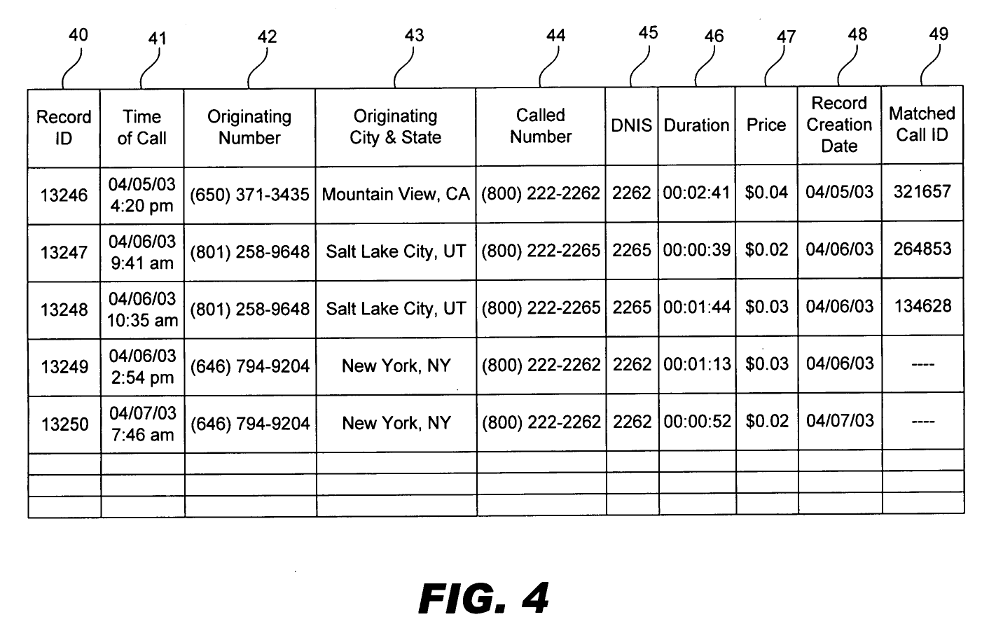

FIG. 4 shows the table structure for the local CDR database, according to one exemplary embodiment.

The record ID (40) is a unique identification code which is assigned to each downloaded CDR record. This code may be previously assigned by the phone company that created the CDR entry or it may be generated afterward by the location resolution system (13, FIG. 1).

The time of call (41), duration (46), and, optionally, the called number (44) or DNIS (45) fields are used to correlate the CDR records with received call records of calls from monitored personnel. The received call database (29, FIG. 3) includes fields containing similar data that is recorded for each incoming call from monitored personnel.

According to another embodiment, additional fields in the local CDR database (30, FIG. 3) are also used to match corresponding calls. For example, if an employee enters a location code or enters the number of the originating call, then the fields for originating city and state (43) or originating number (42) can be used to correlate the CDR record to the received call record. In this case, the matching process is still valuable even though the employee entered location information. By matching calls to the CDR records, users of the system can verify that an employee was actually at the location indicated and verify exactly when the employee arrives and departs.

Once a CDR record is matched to a received call record, the identification code for the matching received call record is placed in the matched call ID (49) field. This field links the two matched records and may also exclude matched CDR records from additional searches. Once a call is matched, the CDR fields for originating city and state (43) and originating number (42) reveal the actual location of the employee. More precise location data may also be obtained and recorded depending on the system.

The field indicating the price (47) of calls can be used for billing or company records.

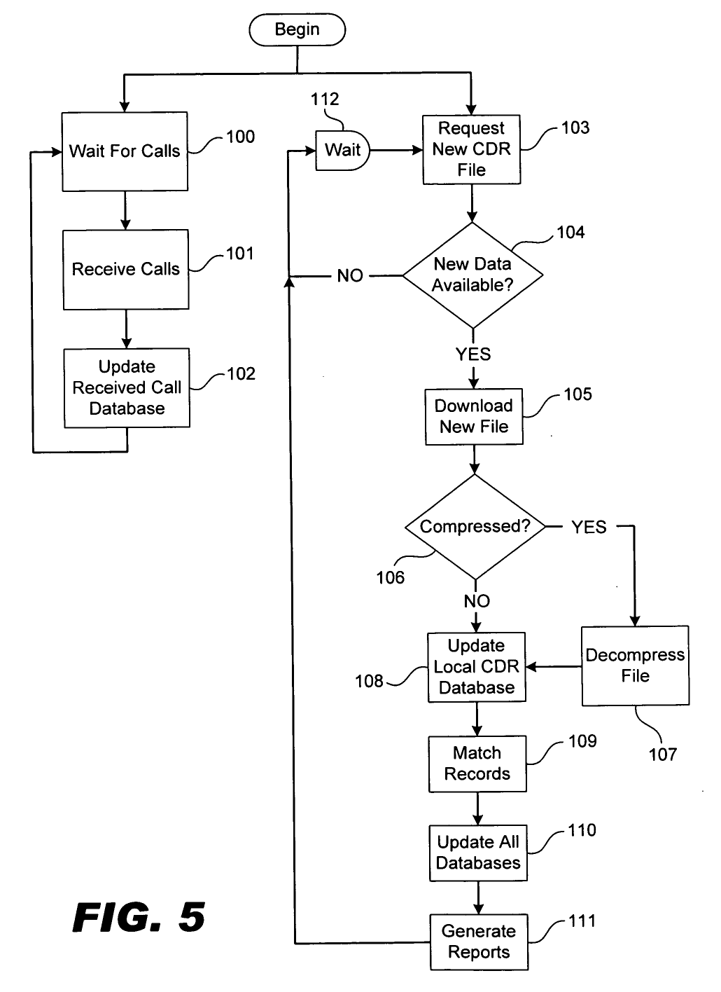

FIG. 5 illustrates a method of operation of a location resolution system, according to one exemplary embodiment.

Initially, the telephony components of the location resolution system wait for received calls to be received from monitored personnel (step 100). This step may take place while additional steps are in progress.

Eventually, calls from remote employees or other personnel are received (step 101). During this step, data is received and recorded from the remote personnel and information is gathered about the call, such as the duration and start and end times of the call.

Once a call is completed, the information gathered is recorded as a record in the received call database (step 102). After the record is completed, the system repeats steps 100-102 son long as there are additional incoming calls.

CDR records may be processed concurrently with steps 100-102. New CDR records are requested from the phone company's server or website (step 103). CDR records may be requested from multiple phone company servers.

Next, it is determined if new CDR data is available (step 104). If data is available, the data is downloaded (step 105). If not, the system will wait (step 112) for some pre-determined interval before requesting CDR data again.

The downloaded data is tested to determine if the data is compressed (step 106). If the CDR data is not compressed, the records are imported directly into the local CDR database (step 108). Otherwise, the data is processed and decompressed (step 107) before being imported into the local CDR database (step 108).

Next, CDR entries are matched to records of calls received from monitored personnel (step 109). An example of the matching process is detailed below in connection with FIGS. 7-9.

Each database is updated with data generated from successful matches (step 110).Reports are then generated and distributed to appropriate recipients (step 111). The system then waits until it is time to request new CDR data (step 112).

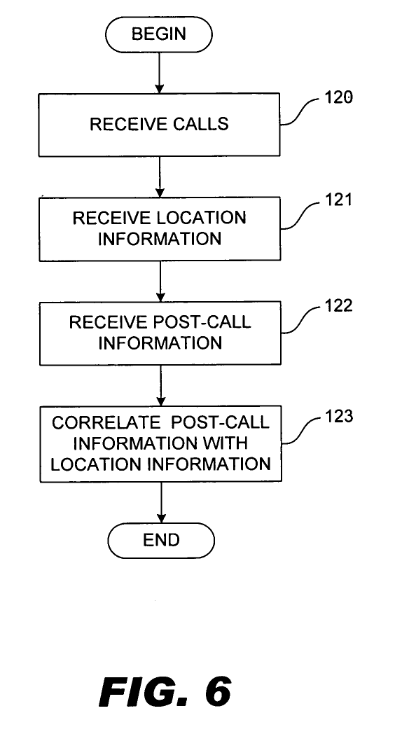

FIG. 6 illustrates the process of location resolution of phone calls, according to one exemplary embodiment. As described above, calls from monitored personnel are received from various remote locations (step 120). At least one phone number is available so that monitored personnel, such as employees, can call to indicate, for example, their arrival at or departure from a remote work site.

Location information is received from or determined based on the data received during the call with the monitored personnel (step 121). This location information is received or determined after a call has been established, but needs not explicitly name a location. After monitored personnel enters a client ID code, for example, information about client locations could indicate the location from which the call should have originated. Similarly, the originating location of a call could be inferred from an employee's ID code by referencing the remote assignments scheduled for that employee. The information may be received in a variety of forms, including, but not limited to, touchtone dialing, rotary dialing, and voice communication.

When the communication with the monitored personnel is concluded, post-call information, e.g., CDR data, is received (step 122). One exemplary embodiment receives this information in the form of CDR files from at least one telephone company. These records may not be generated and/or received until several days after a call is completed. The post-call information is then correlated with the location information to verify the originating location of the calls received from monitored personnel (step 123).

FIG. 7 illustrates the process of matching received calls to CDR data, according to one exemplary embodiment. First, it is determined if new CDR data is available (step 201). If no new data is available, then step 201 is repeated periodically or at a predetermined frequency. When a new file is available, the new file is downloaded and processed (step 202).

The downloaded CDR data is then added to the local CDR database (step 201). As mentioned above, this may involve decompressing or decrypting the CDR data.

The first and last dates of the imported CDR data are then determined (step 204). These values determine the set of received calls from monitored personnel that will be compared to the new group of CDR data. This accordingly facilitates the matching of received calls to CDR data by limiting the number of received calls that need to be compared to a given set of CDR data

As part of determining which received calls will be compared to a given set of CDR data, a bias is set (step 205). This bias represents and accounts for any potential difference, if any, between the clock of the telephone company's network used to generate the CDR data and the clock of the location resolution system used to generate the received call records. In many cases, it is acceptable to use a default bias of zero. However, in some embodiments the bias is arbitrarily set to a non-zero value to make certain that received calls are matched to CDR data.

In some embodiments, the bias may be determined more accurately and overrides any default value for a given set of CDR entries. In one embodiment, for example, periodic calls to phone numbers with unique DNIS digits are used to measure the offset between the system clock and the phone network clock. Another embodiment uses a group of calls to determine the bias, using the time interval between calls to align the records more accurately. The average bias or the most common bias then replaces the default value.

The offset window is set to an initial value of zero (step 206). Since CDR records may be created using various unsynchronized clocks, the timestamps for received calls may not exactly match CDR timestamps. During the matching process, a time offset specifies the range of suitable times to consider as potential matches. After each iteration of the matching process, this offset is increased to consider a larger set of CDR entries.

An offset of one, for example, would consider all calls that are within one second ahead or one second behind the timestamp of the received call. On the fifth iteration, the offset would equal four, and CDR entries between −4 and +4 seconds of the received call timestamp would be considered. This allows the closest matching records to be correlated first

At the beginning of each iteration, the offset value is checked (step 207) to ensure that it remains within a certain maximum value. If the window exceeds that value, then the matching process has finished and the process repeats with step 201. In the embodiment depicted in FIG. 7, the maximum allowable offset value is 10. Additional embodiments may use a maximum value that is higher or lower.

Next, a set of received calls is sequentially compared to appropriate CDR records. The list of received calls is checked to determine if additional calls remain to be matched for the current iteration (step 208). If additional received calls have not been compared during the current iteration, then the next call is selected (step 209). After each received call has been compared using the current offset value, the offset is increased by one (step 211) and the process continues (step 207).

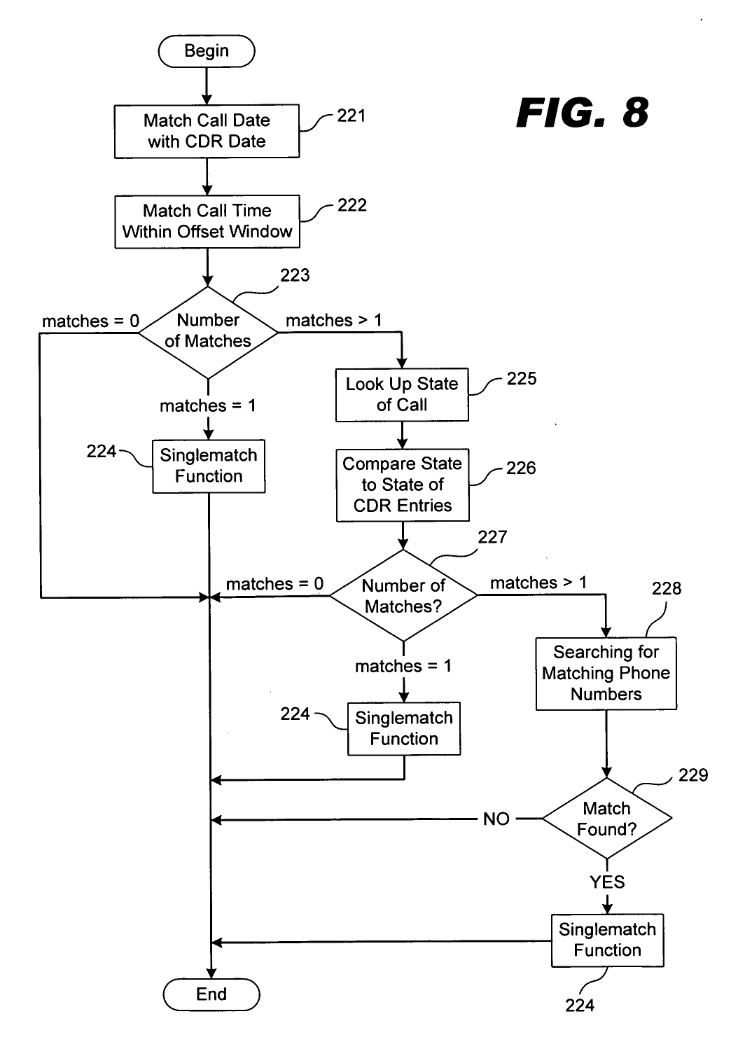

A single received call is compared to a set of CDR records (step 210). This subroutine, referred to as the QueryMatch function, is detailed in FIG. 8. After matching has been attempted with the current call, the process continues (step 208) and will process the remaining calls.

FIG. 8 illustrates the process of matching a received call to its corresponding CDR entry, according to one exemplary embodiment.

The process begins with the date of the single received call to be matched being compared to the dates of the unmatched CDR entries (step 221). Only CDR entries with dates that exactly match the date of the received call remain in consideration. Special cases, such as calls very close to midnight, may be processed further to include additional potential matches. CDR records outside the time offset window are eliminated (step 222).

The next action is determined based on the number of CDR records remaining in the set of potentially matching entries (step 223). If no matches are found, the process ends. If only one match is found, the SingleMatch subroutine is executed (step 224) and then the process ends.

If multiple CDR records match the timestamp of the received call, then information received during a call, such as a client code or job code, is used to determine the city or state where the call most likely originated (step 225).

Probable client locations from the previous step are compared to the originating locations of each remaining CDR entry (step 226).

If no CDR locations match client locations for the received call, the process ends (step 277). If only one match is found, the SingleMatch subroutine is executed (step 224) and then the process ends.

If multiple CDR records still match the location, date, and time of the received call, the phone numbers listed in the matching CDR records are compared to records of known client phone numbers (step 228). The list of known phone numbers may include recently used numbers and/or official numbers verified by a client.

If the originating phone number of a CDR record matches a valid phone number for the client associated with the received call, the CDR record is considered a match. If a single match is found, the SingleMatch subroutine is executed (step 224) and the process ends. Otherwise, the process ends without a valid match.

In the majority of cases, the call and CDR record will be correctly matched with the steps mentioned. Other embodiments may use additional employee data entered to refine the matching process.

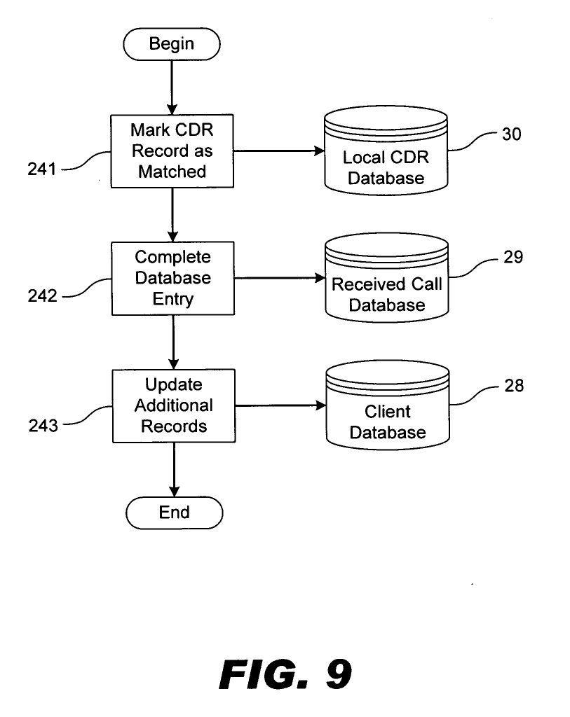

FIG. 9 illustrates the process used to update client and call information once a match has been made, according to one exemplary embodiment.

This process, referred to as the SingleMatch function, is executed once a CDR record has already been matched to a received call.

First, the CDR entry is marked as matched to exclude the record from future matching searches (step 241). The local CDR database (30) is also updated with a code for the received call associated with the CDR entry.

The received call entry in the received call database (29) is then completed with the information extracted from the matching CDR entry (step 242). The received call database (29) will be updated with an identification code or link associating the received call entry with the corresponding CDR entry.

Additional records, such as those in the client database (28), are updated to reflect data extracted from the successful match of phone records (step 243). For example, one embodiment logs each successful match as “clocking in” or “clocking out” on a timecard for a certain employee. When a match is successfully made, the timecard for the calling employee is updated to reflect the recently verified time of arrival or time of departure from the remote location.

The preceding description has been presented only to illustrate and describe embodiments of the invention. It is not intended to be exhaustive or to limit the invention to any precise form disclosed. Many modifications and variations are possible in light of the above teaching.

What is claimed is:

1. A method of tracking personnel, comprising:
receiving incoming communications from said personnel via a telephone network from various locations; and
matching records of said incoming communications with phone company data generated after calls are completed for billing purposes, said matching being conducted so as to verify a location from which each incoming communication originated.

2. The method of claim 1, wherein said phone company data includes Call Detail Records.

3. The method of claim 1, wherein said phone company data includes client information.

4. The method of claim 1, wherein said records of said incoming communications comprise time, date and duration

5. The method of claim 4, wherein said records of incoming communications comprise Dialed Number Identification Service (DNIS) digits.

6. The method of claim 4, wherein said matching comprises comparing said time, data and duration of an incoming communication with said phone company data.

7. The method of claim 1, further comprising receiving and recording additional data from each of said incoming communications.

8. The method of claim 7, wherein said additional data includes any of an identification of personnel, an identification of a client or an identification of a task.

9. The method of claim 1, further comprising generating reports based on said matching of records of incoming communications with phone company data.

10. The method of claim 1, further comprising verifying and augmenting records of said incoming communications using caller-ID or Automatic Number Identification (ANI).

11. A method of correlating received call information with post call information comprising:
selecting a set of call records generated post-call by a phone company for billing purposes; and
matching records of individual received calls with calls in a set of said selected call records over a specified time period;
wherein said specified time period includes an offset from a range of times at which said received calls were received.

12. The method of claim 11, further comprising adjusting said offset and repeating said matching.

13. The method of claim 11, wherein said call records are selected by date.

14. The method of claim 11, wherein matched records are excluded from additional searches.

15. The method of claim 11, further comprising providing a maximum value for said offset.

16. The method of claim 11, further comprising setting a bias value for said offset.

17. The method of claim 11, wherein said matching comprises comparing time and duration information to determine matches.

18. A system of tracking personnel, comprising:
means receiving incoming communications from said personnel via a telephone network from various locations; and
means for automatically matching records of said incoming communications with phone company data generated after calls are completed for billing purposes so as to verify a location from which each incoming communication originated.

19. The system of claim 18, wherein said phone company data includes Call Detail Records.

20. The system of claim 18, wherein said means for automatically matching records comprises means for accounting for an offset between a clock used to generate said records of incoming communications and a clock used to generated said phone company data.
